(19) United States
(12) Patent Application Publication
(10) Pub. No.: US 2007/0080663 A1
(43) Pub. Date: Apr. 12, 2007

(54) Portable charger with a rechargeable back-up battery

(76) Inventor: Jeff Obering, Cedar City, UT (US)

Correspondence Address: TERRENCE J. EDWARDS;CLAYTON, HOWARTH & CANNON, P.C., P.O. BOX 1909, SANDY, UT, 84091, US

(21) Appl. No.: 11/580,274

(22) Filed: Oct. 11, 2006

Related U.S. Application Data
(60) Provisional application No. 60/726,000, filed on Oct. 11, 2005.
(60) Provisional application No. 60/756,447, filed on Jan. 4, 2006.

(51) Int. Cl. H02J 7/00

(52) U.S. Cl. 320/114

(57) ABSTRACT

A portable battery charger with a rechargeable back-up battery is disclosed. The portable charger comprises a first electrical connector for coupling the charger to an external power source, a second electrical connector for coupling the charger to a battery of a portable electronic device, a power converter, a back-up battery, and charging management circuitry. The portable charger is able to charge the battery of the portable electronic device from either its back-up battery or the external power source.

### CROSS-REFERENCE TO RELATED APPLICATIONS

This application claims the benefit of U.S. Provisional Application No. 60/726,000 filed Oct. 11, 2005 and U.S. Provisional Application No. 60/756,447 filed Jan. 4, 2006, which are both hereby incorporated by reference herein in their entireties, including Appendices A, B and C of Application No. 60/756,447, including but not limited to those portions that specifically appear hereinafter, the incorporation by reference being made with the following exception: In the event that any portion of the above-referenced provisional applications are inconsistent with this application, this application supercedes said above-referenced provisional applications.

### STATEMENT REGARDING FEDERALLY SPONSORED RESEARCH OR DEVELOPMENT

Not Applicable.

### BACKGROUND

1. The Field of the Invention

The present disclosure relates generally to battery chargers for electronic devices, and more particularly, but not necessarily entirely, to a charger unit with a back-up battery for supplying power to portable electronic devices when direct connection to a power source is unavailable.

2. Description of Related Art

Portable electronic devices (“PEDs”) include, inter alia, cell phones, lap tops, personal digital assistants, gaming devices, and cameras. PEDs typically include a rechargeable battery such as Nickel-Metal Hydride and Lithium-ion batteries to avoid the cost of replacing the batteries every few days. To recharge a battery in a PED, a battery charger is used.

A battery charger is an electronic device that is plugged into a power source and connected to a rechargeable battery to restore the state of charge in the battery. A battery charger generally provides a controlled voltage and current to ensure that a battery is properly charged and not damaged in the process. Prior to the disclosure described herein, battery chargers were available in various forms. Previously available battery chargers included desk top chargers, portable chargers that plug into AC power outlets, and portable chargers that plug into power outlets of a vehicle, such as a car.

The previously available battery chargers required a connection to an external power source in order to charge a battery. Without a connection to an external power source, the previously available battery chargers would not function. That is, the previously known battery chargers were useless without a connection to an external power source. For example, when a user is distant from home or a vehicle, a previously known charger could not be used.

At least one attempt has been made to overcome the drawbacks of the previously available charging devices described above. This attempt included a device that was able to charge a battery of a PED using home AC power or vehicle power. The device included an internal charging battery to charge the battery of the PED when home AC power or car power was unavailable. However, this device had one severe drawback of its own in that its internal battery could not be charged by car power, unless the maximum charging voltage of the internal battery was identical to or higher than the voltage of the car power. Further, this device did not provide for a charging management circuit for its internal battery.

These known devices are thus characterized by several disadvantages that may be addressed by the present disclosure. The present disclosure minimizes, and in some aspects eliminates, the above-mentioned failures, and other problems, by utilizing the methods and structural features described herein.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out herein.

### BRIEF DESCRIPTION OF THE DRAWINGS

The features and advantages of the disclosure will become apparent from a consideration of the subsequent detailed description presented in connection with the accompanying drawings in which:

FIG. 1 is a block diagram of an exemplary embodiment of the present disclosure;

FIG. 2 illustrates another exemplary embodiment of the present disclosure;

FIG. 3 illustrates another exemplary embodiment of the present disclosure;

FIG. 4 illustrates another exemplary embodiment of the present disclosure; and

FIG. 5 is an electrical schematic of another exemplary embodiment of the present disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the present structure for a portable charger with a rechargeable reserve or back-up battery is disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present disclosure will be limited only by the appended claims and equivalents thereof.

In describing and claiming the present disclosure, the following terminology will be used in accordance with the definitions set out below.

As used in this specification the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

Applicant has discovered a portable battery charger that is able to charge a battery from either an external power source or a reserve or back-up battery in or as part of the portable battery charger. The back-up battery in the portable battery charger may be maintained at full charge from the external power source. When the portable battery charger is disconnected from the external power source, the portable battery charger can continue to charge the battery from its back-up battery. While the present disclosure is particularly suited for use with PEDs, it can be used to charge any suitable battery.

In one embodiment, the portable battery charger of the present disclosure may be used with a cell phone. When the cell phone's battery has been discharged, the portable battery charger may be used to recharge the cell phone's battery. The recharging can take place with or without an external power source due to the back-up battery of the portable battery charger. The recharging can also be accomplished with a combination of both an external power source and the back-up battery of the portable battery charger.

For example, a user may partly charge the cell phone's battery while driving to work using his or her vehicle's electrical system and the portable battery charger. Upon arriving at work, the user may disconnect the portable charger from the vehicle, and continue to charge the cell phone's battery using the back-up battery of the portable battery charger.

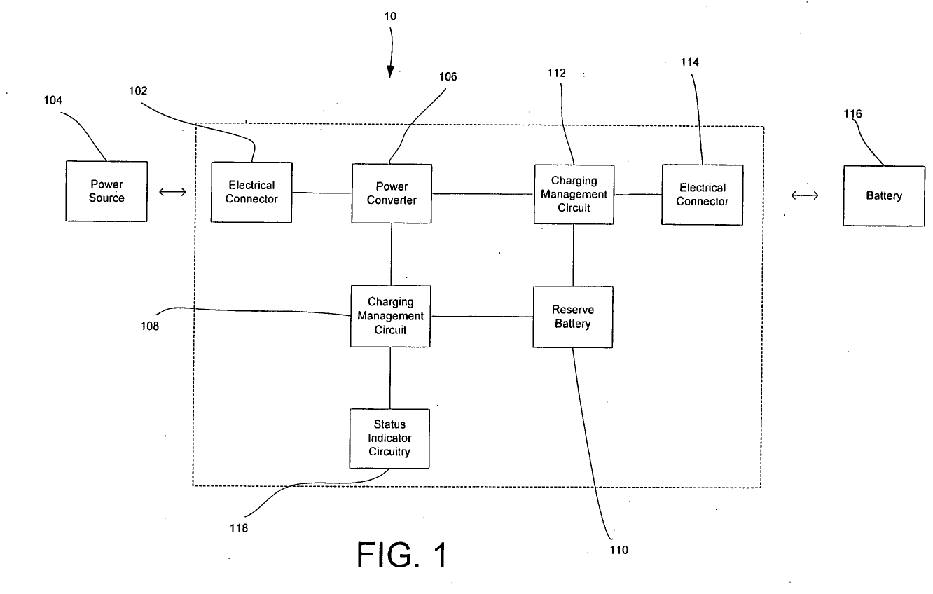

Referring now to FIG. 1, there is illustrated an embodiment of the present disclosure. A charger 10 may be contained in a housing 100. The housing 100 may be made from plastic or any other suitable material without departing from the scope of the present disclosure. Associated with the housing 100 may be an electrical connector 102 for electrically coupling the charger 10 to an external power source 104. The external power source 104 may be of the AC or the DC variety (AC and DC are abbreviations for alternating current and direct current, respectively). For example, the power source 104 may be the AC power system of a home or the DC power system of a vehicle.

The electrical connector 102 should be suitable configured to be electrically coupled to the external power source 104. The electrical connector 102 may be, for example, of the two-pronged variety to mate with a power outlet in a home. Or, the electrical connector 102 may be adapted to couple with a power outlet in a vehicle. For example, it will be appreciated that the connector 102 may be part of the housing 100 and may be cylindrically shaped for interfacing with a 12-volt outlet of a vehicle or other 12-volt source.

The electrical connector 102 may extend from the housing 100 or be formed on an outer wall of the housing 100. The electrical connector 102 may be disposed on the end of an electrical cord (not shown) extending from the housing 100. The electrical connector 102 can be of any type now known or known in the future, so long as it electrically connects the charger 10 to the external power source 104. It should further be understood that the electrical connector 102 may or may not be located within the confines of the housing 100.

A power convertor 106 may convert the power from the power source 104 received through the electrical connector 102. The power converter 106 may be of either the AC to DC or the DC to DC variety. In the case of the AC to DC converter, the converter 106 converts AC power from the power source 104 to DC of the desired voltage. In the case of a DC to DC converter, the converter 106 may drop the voltage of the power source 104 to the desired voltage. It will be appreciated that the power converter 106, or other power converters disclosed herein, may be referred to herein as a means for converting power from an external power source.

A charging management circuit 108 may be located within the housing 100. The charging management circuit 108 may control and/or regulate the charging of a reserve or back-up battery 110. The back-up battery 110 may be charged from the power source 104 via the power convertor 106. As mentioned, the charging management circuit 108 may control and/or regulate the charging of the back-up battery 110. This operation may entail (1) measuring the back-up battery 110 temperature and inhibiting charging if the battery 110 temperature falls outside of acceptable limits; (2) charging the battery 110 in phases, including, a conditioning phase, constant current phase, and constant voltage phase; and (3) discontinuing the charging of the battery 110 when it is at full charge.

An optional additional fourth mode includes the following. When the charging management circuit 108 recognizes that the back-up battery 110 is fully charged, it will switch to a “power saver mode” and an external LED light may then illuminate and indicate the back-up battery 110 is fully charged.

The reserve or back-up battery 110 may be of the rechargeable variety. The back-up battery 110 may have a maximum charging voltage. The power convertor 106 may supply a voltage equal to or less than the maximum charging voltage of the battery 110, even though the voltage of the power supply 104 may exceed the maximum charging voltage of the battery 110.

A second charging management circuit 112 may be contained within the housing 100. The second charging management circuit 112 may control and/or regulate the charging of battery 116 of the portable electronic device. The second charging management circuit 112 may include a voltage detector to detect when the battery 116 may be present and in need of charging. The charging management circuit 112 may also (1) measure the battery 116 temperature and inhibit charging if the battery 116 temperature falls outside of acceptable limits; (2) charge the battery 116 in phases, including, a conditioning phase, constant current phase, and constant voltage phase; and (3) discontinue charging the battery 116 when it is at full charge.

It will be appreciated that the second charging management circuit 112 may operate to gait the charge from the power source 104 or from the reserve battery 110. It will be appreciated that the second charging management circuit 112 (or 508) may be part of a means for enabling a battery of a portable electronic device to be chargeable from either of the external power source or the back-up battery.

An electrical connector 114 may electrically connect to the battery 116 or the PED containing the battery 116. The electrical connector 114 may extend from the housing 100 or be formed on an outer wall of the housing 100. The electrical connector 114 may be disposed on the end of an electrical cord (not shown) extending from the housing 100. The electrical connector 114 can be of any type now known or known in the future, so long as it connects the charger 10 to the battery 116 or the PED containing the battery 116. It should further be understood that the electrical connector 114 may or may not be located within the confines of the housing 100.

Status indicator circuitry 118 may also be included within the housing 100. The status indicator circuitry 118 may determine the charge status of the back-up battery 110 and/or the battery 116. The status indicator circuitry 118 may include one or more light emitting diodes (“LEDs”) to indicate to a user the status of the charge of the back-up battery 110 and/or the battery 116.

The charger 10 may have three primary modes of operation. In the first mode, when the charger 10 is connected to the power source 104 and the battery 116 is present, the charger 10 may charge the battery 116 from the external power source 104. It should be understood that the power from the power source 104 may first be converted by the power converter 106. Further, in this mode, the back-up battery 110 may be charged from the external power source 104. The charging of the back-up battery 110 and the battery 116 may occur simultaneously.

In the second mode, when the charger 10 is not connected to the power source 104 and the battery 116 is present, the battery 116 may be charged from the back-up battery 110, if needed. In this mode, the charger 10 may be portable and can be taken, along with the battery 116, to any location remote of the power source 104.

In the third mode, when the charger 10 is connected to the power source 104 and the battery 116 is not present, then the back-up battery 110 may be charged from the power source 104, if needed. Thus, the charger 10 could be left attached to the power source 104 until needed.

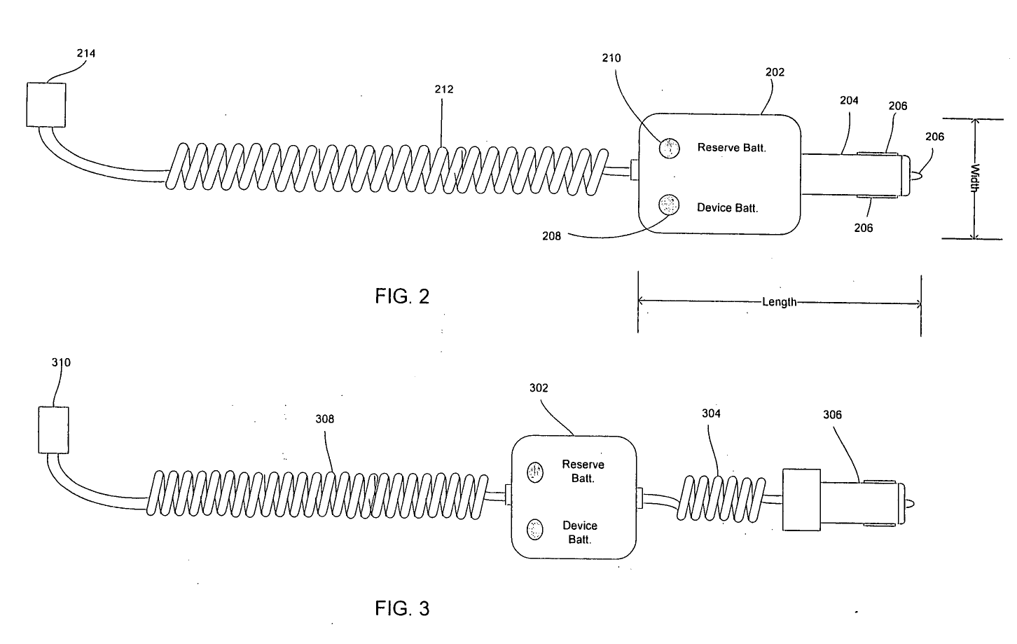

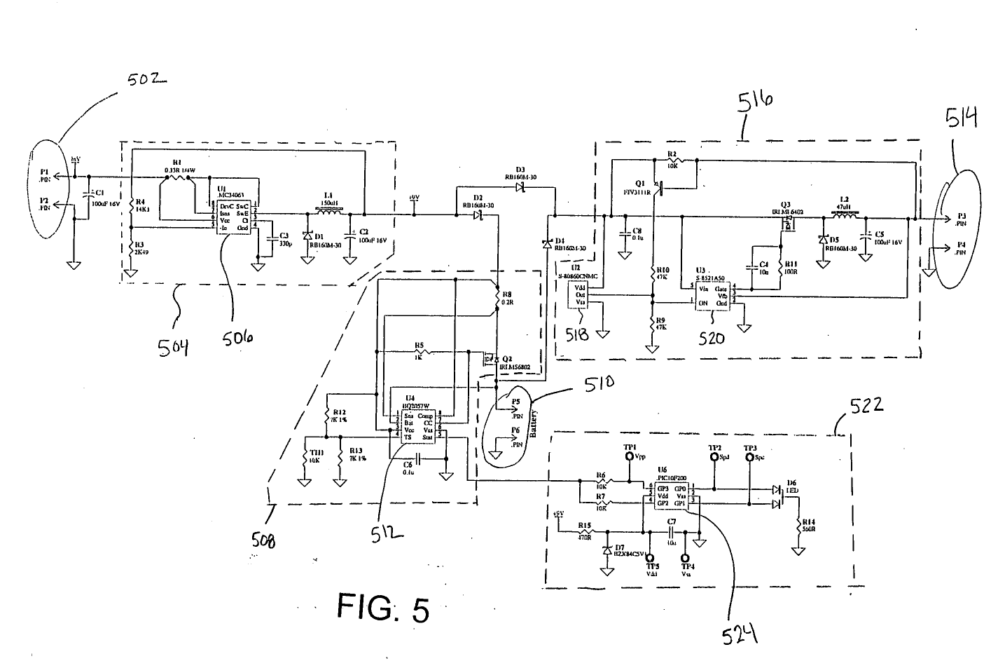

Referring now to FIG. 2, there is shown another embodiment of the present disclosure. A charger 200 may comprise a housing 202. Circuitry and a back-up battery may be located inside of the housing 202. The circuitry may take the form of the circuitry described in relation to FIG. 1 or FIG. 5. In particular, the housing 202 may contain, in addition to a reserve battery, a power converter, status indicator circuitry, and one or more charging management circuits, and extending from the housing 202 may be a male plug 204 adapted to be inserted into a 12-volt outlet of a vehicle. The plug 204 may be of standard design and may comprise electrodes 206 for interfacing with the outlet. It will be appreciated that the male plug 204 may be part of the housing 202 and may be cylindrically shaped for interfacing with a 12-volt outlet of a vehicle or other 12-volt source.

Located on the housing 202 may be LED status indicators 208 and 210. The indicator 208 may inform a user of the status of the charge of an external battery that is charged by the charger 200. The indicator 210 may inform a user of the status of the charge of the back-up battery. When the charge of its respective battery is low, the indicators 208 and 210 may be red. When the charge of its respective battery is full, the indicators 208 and 210 may be green. However, it will be appreciated that any color scheme may be implemented to indicate whether the charge of the battery is low or full.

Extending from the housing 202 may be a power cord 212. The power cord 212 may include a strain relief mechanism such as coils as shown in FIG. 2. Disposed on the end of the cord 212 may be a plug 214. The plug 214 may be adapted to electrically interface with a reciprocal plug on a battery or a PED. Contained in housing 202 may be circuitry and a back-up battery. The circuitry may take the form of the circuitry described in relation to FIG. 1 or FIG. 5. In particular, the housing 202 may contain, in addition to a back-up battery, a power converter, status indicator circuitry, and one or more charging management circuits.

The charger 200 may be operable in three primary modes. In the first mode, when the charger 200 is connected to a power outlet of a vehicle and an external battery is present, the charger 200 may charge the external battery from the vehicle's electrical system. It should be understood that the power from the vehicle may be converted by a power converter inside of the housing 202 of the charger 200. Further, in this mode, the back-up battery may also be charged from the vehicle's electrical system. The charging of the back-up battery in the housing 202 and the external battery attached to plug 214 may occur simultaneously, or separately.

In the second mode, when the charger 200 is not connected to the vehicle and a battery is connected to plug 214, the battery may be charged from the reserve or back-up battery inside of housing 202, if needed. In this mode, the charger 200 may be portable and can be taken and used at any location remote of the vehicle.

In the third mode, when the charger 200 is connected to the vehicle power outlet and an external battery is not present, then the back-up battery in the housing may be charged from the vehicle, if needed. Thus, the charger 200 could be left attached to the power outlet of the vehicle until needed.

The housing 202 and plug 204 may also be structured such that a ratio of a width (W) to a length (L) of the housing 202 and the plug 204 as shown in FIG. 2 may be within a range that may be less than or equal to about 0.5 and about 0.25. More particularly, it has been found that a ratio of the housing that may be between a range of about 0.4 to about 0.3 may be beneficial for the sake of being small enough and light enough to be portable and further may be sufficiently sized to house the necessary circuitry and electrical components of the device. Thus, the size and shape of the housing 202 may be implemented to conveniently tote and carry the device and is also functional to provide power to the device from a power source.

Referring now to FIG. 3, there is shown another embodiment of the present disclosure. A charger 300 may include a housing 302. Inside of the housing 302 may be circuitry and a back-up battery. The circuitry may take the form of the circuitry described in relation to FIG. 1 or FIG. 5. In particular, the housing 302 may contain, in addition to a reserve battery, a power converter, status indicator circuitry, and one or more charging management circuits. A male plug 306 for connecting the charger to a vehicle power outlet may be attached to the housing 302 by an electrical cord 304. A plug 310 may also be attached to the housing 302 by an electrical cord 308. The plug 310 may connect to a battery or a PED. Both the cords 304 and 308 may include a strain relief device, such as coils. The charger 300 may have the same three modes of operation described in relation to charger 200.

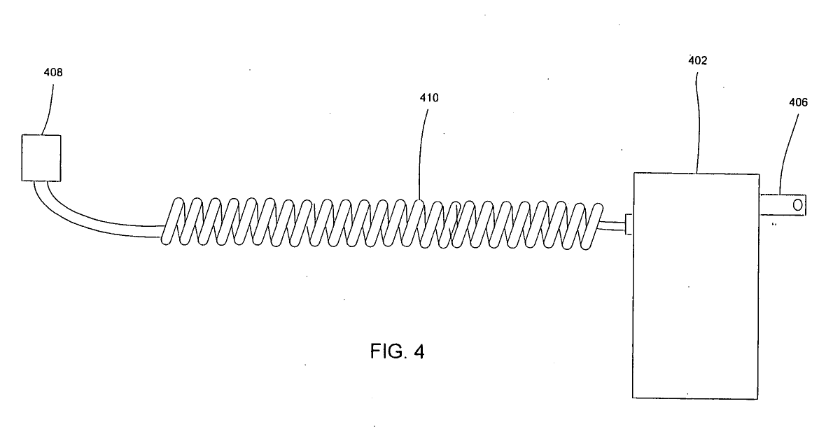

Referring now to FIG. 4, there is shown still another embodiment of the present disclosure. A charger 400 may include a housing 402. Inside of the housing 402 may be circuitry and a back-up battery. The circuitry may take the form of the circuitry described in relation to FIG. 1 or FIG. 5. In particular, the housing 402 may contain, in addition to a reserve battery, a power converter, status indicator circuitry, and one or more charging management circuits. A standard two-pronged plug 406 for connecting the charger 400 to an AC power outlet may extend from the housing 402. A plug 408 may also be attached to the housing 402 by an electrical cord 410. The plug 408 may electrically connect the charger 400 to an external battery or a PED. The cord 410 may include a strain relief device, such as coils. The charger 400 may have the same three modes of operation described in relation to charger 200.

Referring now to FIG. 5, there is shown another exemplary embodiment of a charger 500 according to the present disclosure in the form of an electrical schematic diagram. A pair of pins 502 may connect the charger 500 to an external power source. The external power source may be a DC power source, such as 12-volt power source. Power from the external power source may be fed to a power converter 504.

The power converter 504 may be operable to drop the voltage of the external power source to approximately 9 volts. This may be necessary due to the fact that the maximum allowed charging voltage of some batteries are less than the voltage of the external power source. The power converter 504 may comprise a DC to DC converter using an integrated circuit 506. One suitable integrated circuit for building a DC to DC converter is part number MC34063 manufactured by Texas Instruments.

A charging management circuit 508 may control and/or regulate the charging of a back-up battery. The back-up battery may be connected to pins 510. The charging management circuit 508 may comprise an integrated circuit 512. One suitable integrated circuit is part number BQ2057W manufactured by Texas Instruments. The charging management circuit 508 may have the ability to inhibit charging until the back-up battery's temperature is within user defined thresholds. The charging management circuit 508 may further charge the back-up battery in phases. The first phase is a conditioning phase. The second phase is a constant current. The third phase is a constant voltage. When the back-up battery is fully charged, the charging management circuit 508 may cease charging.

An external battery may be electrically connected to pins 514. The charging of the external battery may be controlled and/or regulated by charging management circuit 516. The charging management circuit 516 may include a voltage detector 518 and a power supply 520. One suitable voltage detector 518 is part number S-80860CNMC manufactured by Seiko Instruments, Inc. One suitable power supply 520 is part number S-8521A50 manufactured by Seiko Instruments, Inc.

A status indicator circuit 522 is shown in FIG. 5. The status indicator circuit 522 may comprise an integrated circuit 524. One suitable integrated circuit 524 is part number PIC10F200 manufactured by Microchip Technology, Inc.

The charger 500 may have three modes of operation. In the first mode, when the charger 500 may be connected to a power outlet of a vehicle and an external battery may be present, the charger 500 may charge the external battery from the vehicle electrical system. Further, in this mode, the back-up battery may be charged from the vehicle's electrical system. The charging of the back-up battery and the external battery may occur simultaneously, or separately.

In the second mode, when the charger 500 is not connected to the vehicle and an external battery may be electrically connected to pins 514, the external battery may be charged from the back-up battery, if needed. In this mode, the charger 500 may be portable and can be taken and used to any location remote of the vehicle.

In the third mode, when the charger 500 may be connected to the vehicle power outlet and an external battery may not be present, then the back-up battery in the housing may be charged from the vehicle, if needed. Thus, the charger 500 could be left attached to the power outlet of the vehicle until needed.

It should be noted that the present disclosure may be used to charge batteries of numerous devices, including a mobile or cellular telephone or other electronic devices, such as MP3 players or other portable music player devices; personal digital assistants or other hand held devices; portable digital televisions; laptop computers; portable digital video disc players or other optical disc technology devices; digital cameras; or any other electronic device.

It will be appreciated that the back-up batteries referenced herein may be a lithium ion battery or any other internal rechargeable battery that is known in the art or which may become known in the art in the future.

The present disclosure may be used when a typical mobile telephone battery, or other electronic device battery, is empty or “dead” and a user is temporarily inconvenienced and cannot be confined to an automobile or next to a typical alternating current (A/C) wall plug, which will allow a user to use a standard, prior art mobile telephone charger.

It will be appreciated that the present disclosure may further comprise a belt clip (not shown) or other device for easy transport of the chargers described herein, when the user's mobile telephone battery, or other electronic device battery, is empty or “dead.” Thus, chargers according to the present disclosure may be placed in a user's pocket or clipped onto a belt while the user continues talking on the phone or the phone is placed on standby.

It will be appreciated that the back-up batteries described herein may be a lithium ion 4.0v, 1000 mAh battery, or any other prior art battery known or that may become known in the future in the art. The actual size and capacity of the battery may be determined by those of skill in the art. However, the capacity of the back-up battery may at least be similar or comparable to existing cellular phone batteries, or other electronic device batteries, when in use allowing similar “talk” times and “standby” times.

It will be appreciated that the structure and apparatus disclosed herein is merely one example of a means for converting power from an external power source, and it should be appreciated that any structure, apparatus or system for converting power from an external power source, which performs functions the same as, or equivalent to, those disclosed herein are intended to fall within the scope of a means for converting power from an external power source, including those structures, apparatus or systems for converting power from an external power source, which are presently known, or which may become available in the future. Anything which functions the same as, or equivalently to, a means for converting power from the external power source, falls within the scope of this element.

In the foregoing Detailed Description, various features of the present disclosure are grouped together in a single embodiment for the purpose of streamlining the disclosure. This method of disclosure is not to be interpreted as reflecting an intention that the disclosure requires more features than are expressly recited. Rather, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. An apparatus for charging a battery of a portable electronic device, the apparatus comprising:
a first electrical connector for providing power from an external power source;
a power converter for converting the power from the external power source;
a back-up battery;
a first charging management circuit for controlling the charging of the back-up battery with the converted power from the power converter; and
a second electrical connector for electrically connecting the battery of the portable electronic device to the back-up battery and the external power source;
wherein the battery of the portable electrical device is chargeable from both the external power source and the back-up battery.

2. The apparatus of claim 1, wherein the first electrical connector is configured and dimensioned to electrically couple to a vehicle's electrical system.

3. The apparatus of claim 1, wherein the first electrical connector is configured and dimensioned to electrically couple to one of a DC power system and an AC power system.

4. The apparatus of claim 1, wherein the power converter is a DC to DC converter.

5. The apparatus of claim 1, wherein the power converter is an AC to DC converter.

6. The apparatus of claim 1, wherein the first charging management circuit comprises an integrated circuit.

7. The apparatus of claim 1, wherein the back-up battery has a maximum charging voltage.

8. The apparatus of claim 1, wherein the first charging management circuit charges the back-up battery in different phases.

9. The apparatus of claim 8, wherein the phases include at least one of the following: a conditioning phase, a constant current phase, and a constant voltage phase.

10. The apparatus of claim 1, wherein the apparatus further comprises a second charging management circuit for controlling the charging of the battery of the portable electronic device.

11. The apparatus of claim 10, wherein the second charging management circuit comprises a voltage detector.

12. The apparatus of claim 10, wherein the second charging management circuit ceases charging the battery of the portable electronic device when the battery has reached a full charge.

13. The apparatus of claim 1, wherein the apparatus further comprises a visual status indicator for indicating that the battery of the portable electronic device is fully charged.

14. The apparatus of claim 1, wherein the apparatus further comprises a cord having a free end, the second electrical connector being disposed on the free end of the cord.

15. The apparatus of claim 14, wherein the second electrical connector is adapted to be attached to a cell phone battery.

16. An apparatus for charging a battery of a portable electronic device, the apparatus comprising:
a first electrical connector for providing power from an external power source, the external power source having a specified voltage;
a power converter for converting power from the external power source;
a back-up battery having a maximum charging voltage;
a first charging management circuit for controlling the charging of the back-up battery with the converted power from the power converter; and
a second electrical connector for electrically connecting the battery of the portable electronic device to the back-up battery and the external power source such that the battery of the portable electronic device is chargeable from both the external power source and the back-up battery;
wherein the maximum charging voltage of the back-up battery is less than the specified voltage of the external power source.

17. The apparatus of claim 16, wherein the first electrical connector is configured and dimensioned to couple to a vehicle's electrical system.

18. The apparatus of claim 16, wherein the first electrical connector is configured and dimensioned to couple to one of a DC power system and an AC power system.

19. The apparatus of claim 16, wherein the power converter is a DC to DC converter.

20. The apparatus of claim 16, wherein the power converter is an AC to DC converter.

21. The apparatus of claim 16, wherein the first charging management circuit comprises an integrated circuit.

22. The apparatus of claim 16, wherein the first charging management circuit charges the back-up battery in different phases.

23. The apparatus of claim 22, wherein the phases include at least one of the following: a conditioning phase, a constant current phase, and a constant voltage phase.

24. The apparatus of claim 16, wherein the apparatus further comprises a second charging management circuit for controlling the charging of the battery of the portable electronic device.

25. The apparatus of claim 24, wherein the second charging management circuit comprises a voltage detector.

26. The apparatus of claim 24, wherein the second charging management circuit ceases charging the battery of the portable electronic device when the battery has reached a full charge.

27. The apparatus of claim 16, wherein the apparatus further comprises a visual status indicator for indicating that the battery of the portable electronic device is fully charged.

28. The apparatus of claim 16, wherein the apparatus further comprises a cord having a free end, the second electrical connector being disposed on the free end of the cord.

29. The apparatus of claim 28, wherein the second electrical connector is adapted to be electrically coupled to a cell phone battery.

30. An apparatus for charging a battery of a portable electronic device, the apparatus comprising:
a housing;
a first electrical connector for electrically coupling to an external power source, wherein the first electrical connector forms part of the housing;
a means for converting power from the external power source, wherein the means for converting power from the external source is located within the housing;
a back-up battery disposed within the housing;
a first charging management circuit for controlling the charging of the back-up battery with the converted power from the means for converting power from the external source, wherein the first charging management circuit is disposed within the housing; and
a second electrical connector for connecting the battery of the portable electronic device to the housing;
wherein the battery of the portable electrical device is chargeable from both the external power source and the back-up battery.

31. The apparatus of claim 30, wherein the apparatus further comprises a first cord extending from the housing, the first cord having a free end, wherein the second electrical connector is disposed on the free end of the first cord.

32. The apparatus of claim 31, wherein the second electrical connector is adapted to be electrically coupled to the battery of the portable electronic device.

33. The apparatus of claim 32, wherein the apparatus further comprises a second charging management circuit located within the housing for controlling the charging of the battery of the portable electronic device.

34. The apparatus of claim 33, wherein the apparatus further comprises a visual status indicator for indicating that the battery of the portable electronic device is fully charged.

35. The apparatus of claim 34, wherein the back-up battery has a maximum charging voltage and the external power source has a specified voltage; and wherein the maximum charging voltage of the back-up battery is less than the specified voltage of the external power source.

36. The apparatus of claim 35, wherein the second charging management circuit comprises a voltage detector.

37. The apparatus of claim 36, wherein the means for converting power from the external source is a DC to DC power converter.

38. The apparatus of claim 37, wherein the apparatus further comprises a second cord extending from the housing, the second cord having a free end, the first electrical connector being disposed on the free end of the second cord.

39. The apparatus of claim 37, wherein the housing has a width and a length, wherein the ratio of the width to the length of the housing is within a range of about 0.25 to about 0.5.

40. An apparatus for charging a battery of a portable electronic device, the apparatus comprising:
a first electrical connector for providing power from an external power source;
a power converter for converting the power from the external power source;
a back-up battery;
a first charging management circuit for controlling the charging of the back-up battery with the converted power from the power converter;
a second charging management circuit for controlling the charging of a battery of a portable electronic device;
a second electrical connector for electrically connecting the battery of the portable electronic device to the back-up battery and the external power source;
a means for enabling a battery of a portable electronic device to be chargeable from either of the external power source or the back-up battery.

41. The apparatus of claim 40, wherein said means for enabling includes at least the second charging management circuit.
